(19) United States
(12) Patent Application Publication
(10) Pub. No.: US 2026/0284893 A1
(43) Pub. Date: Sep. 24, 2026

(54) IMAGE PROCESSING DEVICE

(71) Applicant: FANUC CORPORATION, Minamitsuru-gun, Yamanashi (JP)

(72) Inventors: Junichirou YOSHIDA, Minamitsuru-gun, Yamanashi (JP); Yuta NAMIKI, Minamitsuru-gun, Yamanashi (JP)

(73) Assignee: FANUC CORPORATION, Minamitsuru-gun, Yamanashi (JP)

(21) Appl. No.: 19/471,941

(22) PCT Filed: Apr. 11, 2023
(86) PCT No.: PCT/JP2023/014688

§ 371 Date: Oct. 2, 2025

(51) Int. Cl. B25J 9/16

(52) U.S. Cl. CPC B25J 9/1697

(57) ABSTRACT

Provided is an image processing device comprising: an image acquisition unit that acquires an image obtained by a vison sensor imaging a target; a robot position acquisition unit that acquires the position of a robot that can grip and move the target; a storage unit that stores the position of a feature part of the target on a first image obtained by the vision sensor imaging the target in a state in which the robot has placed the target at a first position; and a feature position identification unit that identifies the position of the feature part of the target on a second image obtained by the vison sensor imaging the target in a state in which the robot has placed the target at a second position on the basis of the position of the robot at the time the robot placed the target at each of the first position and the second position, the position of the vision sensor at the time of the imaging of each of the first image and the second image, and the position of the feature part on the first image.

### FIELD

The present disclosure relates to an image processing device.

### BACKGROUND

A robot system configured to perform work for detecting a position of a target object by a visual sensor and picking up the target object by a robot, based on a detection result, is known. In such a robot system, as a technique for improving a recognition rate of a target object by the visual sensor, a technique for constructing a learning model by using a learning image in which the target object is captured may be used (for example, see PTLs 1 to 3).

### CITATION LIST

### Patent Literature

[PTL 1] Japanese Unexamined Patent Publication (Kokai) No. 2020-82315 A
[PTL 2] Japanese Unexamined Patent Publication (Kokai) No. 2019-56966 A
[PTL 3] Japanese Unexamined Patent Publication (Kokai) No. 2016-203293 A

### SUMMARY

### Technical Problem

In order to construct a learning model which enables improvement of a recognition rate of a target object by a visual sensor, a great number of learning images need to be prepared. In general, in order to prepare a great number of learning images, a worker needs to repeatedly perform, for example, work for capturing a great number of images while changing the arrangement of target objects, and, furthermore, associating a correct answer, such as a position of the target object on an image, with each of the images and the like. A technique that enables automatic acquisition of learning images is desired.

### Solution to Problem

One aspect of the present disclosure is an image processing device including: an image acquisition unit configured to acquire an image of a target object captured by a visual sensor; a robot position acquisition unit configured to acquire a position of a robot configured to be movable while grasping the target object; a storage unit configured to store a position of a feature portion of the target object on a first image of the target object captured by the visual sensor in a state where the robot arranges the target object in a first position; and a feature position specification unit configured to specify a position of the feature portion of the target object on a second image of the target object captured by the visual sensor in a state where the robot arranges the target object in a second position, based on a position of the robot when the robot arranges the target object in each of the first position and the second position, a position of the visual sensor when each of the first image and the second image is captured, and a position of the feature portion on the first image.

The objects, the features, and the advantages, and other objects, features, and advantages will become more apparent from the detailed description of typical embodiments of the present invention illustrated in the accompanying drawings.

### BRIEF DESCRIPTION OF DRAWINGS

FIG. 1 is a diagram illustrating a configuration of a robot system including an image processing device according to one embodiment.

FIG. 2 is a functional block diagram related to the image processing device and a robot controller.

FIG. 3 is a flowchart illustrating processing in a preparation stage for collecting a learning image according to a first embodiment.

FIG. 4 is a flowchart illustrating learning image acquisition processing according to the first embodiment.

FIG. 5 is a diagram illustrating calculation of a feature position on an image.

FIG. 6 is a flowchart illustrating box picking-up processing during the actual operation of the robot system.

FIG. 7 is a flowchart illustrating processing in a preparation stage for collecting a learning image according to a second embodiment.

FIG. 8 is a flowchart illustrating learning image acquisition processing according to the second embodiment.

### DESCRIPTION OF EMBODIMENTS

Next, embodiments of the present disclosure will be described with reference to drawings. A similar configuration portion or a similar functional portion is denoted by the same reference sign in the referred drawings. A scale is appropriately changed in the drawings in order to facilitate understanding. An aspect illustrated in the drawing is one example for implementing the present invention, and the present invention is not limited to the illustrated aspect.

It should be noted that, in the present specification, when a “position” is simply described for a robot, a visual sensor, an end effector mounted on the robot, and a coordinate system, the concept of the position also includes a posture thereof unless otherwise specified.

### First Embodiment

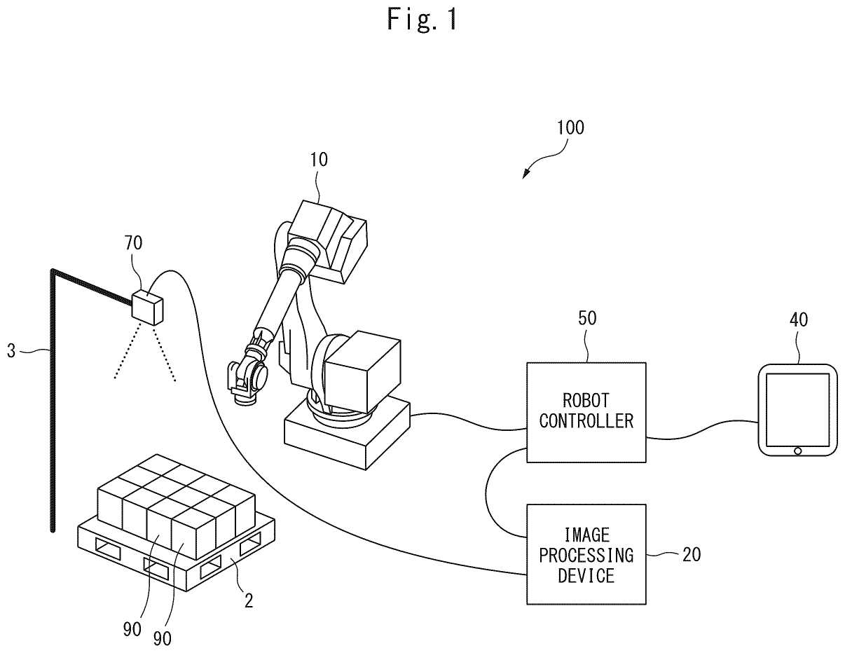

FIG. 1 is a diagram illustrating a configuration of robot system 100 including image processing device 20 according to one embodiment. Image processing device 20 has functions of controlling visual sensor 70 and also executing image processing on an image captured by visual sensor 70. As illustrated in FIG. 1, robot system 100 includes robot 10, robot controller 50 that controls robot 10, teaching device 40 connected to robot controller 50, visual sensor 70, and image processing device 20. For example, robot system 100 can detect a target object arranged in a work region by visual sensor 70, and perform handling of the target object with a hand (not illustrated) mounted on robot 10.

Robot 10 is a vertical articulated robot in the present embodiment, but a robot of other types such as a parallel link robot and a dual arm robot may be used according to the purpose of work. Robot 10 can perform desired work with an end effector attached to a wrist portion of the robot.

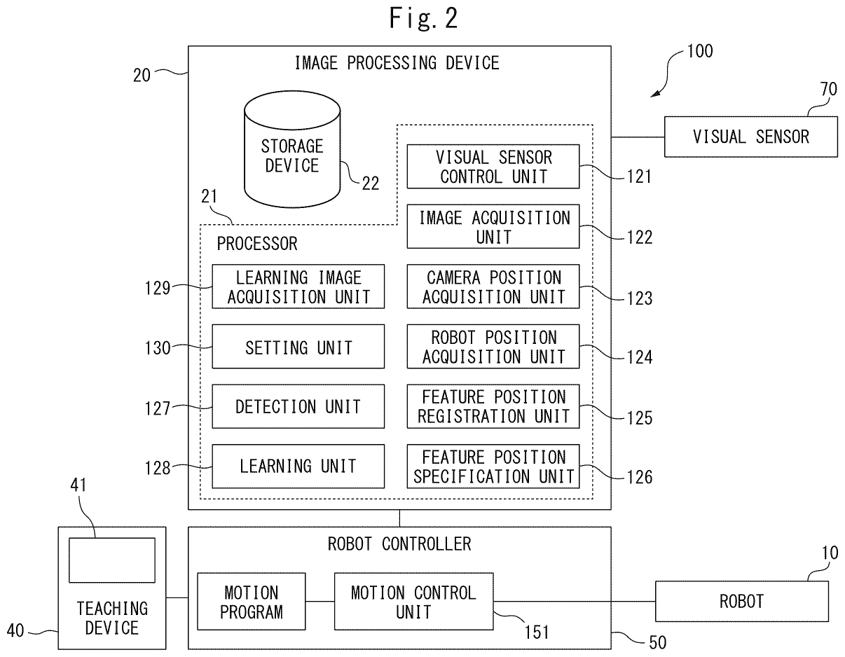

In the present embodiment, since a three-dimensional object such as box 90 is assumed as a target object of recognition by visual sensor 70, a three-dimensional camera that can acquire a distance image is used as visual sensor 70. As the three-dimensional camera, a time-of-flight (TOF) camera that captures a distance image by a light flight time method, a stereo camera including two cameras, or the like may be used. In the present embodiment, as illustrated in FIG. 1, a case where visual sensor 70 is fixedly installed on stand 3 in a workspace is assumed. Visual sensor 70 has already been subjected to calibration, and the position of visual sensor 70 in the workspace is already known in robot controller 50. By using calibration data, image processing device 20 can obtain a position on an image captured by visual sensor 70 as a position on a coordinate system (such as a robot coordinate system) set in the workspace. The calibration data (such as position information about visual sensor 70) are stored in storage device 22 (see FIG. 2) of image processing device 20.

Robot system 100 can perform work for measuring a position of box 90 as a target object loaded on pallet 2 by image processing device 20 (visual sensor 70), and picking up box 90 by robot 10. In a case where there is a clear feature such as a printed letter or a pattern on a surface of a box when the position of the box is measured by visual sensor 70, the position of the box can be determined by detecting the feature. On the other hand, in a case where there is no such a feature on a box, an outer shape of the box needs to be measured in order to use the outer shape of the box as a feature. However, it may be difficult to measure an outer shape of a box due to reasons as follows.
An outer shape of a box may be difficult to recognize due to the influence of a background.
When boxes are in close contact, an outer shape of a box may be difficult to recognize.
A tape and the like on a box surface may be recognized as an outer shape of a box.

In order to solve the problems as described above and improve the recognition rate of a target object, image processing device 20 according to the present embodiment has a function of learning a relationship between a great number of images in which the target object is captured and feature positions on the images. Image processing device 20 according to the present embodiment automates acquisition of a great number of images in which a target object is captured and specification of a feature position in each of the images.

Image processing device 20 may be formed of a device specifically for image processing, or may be formed of a general-purpose information processing device such as a personal computer (PC). Image processing device 20 may have a hardware configuration as a general computer including processor 21, a memory (such as a ROM, a RAM, and a non-volatile memory), storage device 22, an input/output interface, a network interface, and the like (see FIG. 2). Image processing device 20 may further include a display unit and an operation unit as a hardware component.

FIG. 1 illustrates the example in which image processing device 20 is formed as a device provided separately from robot controller 50, but a function as image processing device 20 may be embedded in robot controller 50.

Robot controller 50 controls the motion of robot 10 according to a motion program or a command from teaching device 40. Robot controller 50 may have a hardware configuration as a general computer including a processor, a memory (such as a ROM, a RAM, and a non-volatile memory), a storage device, an operation unit, an input/output interface, a network interface, and the like.

Teaching device 40 is connected to robot controller 50, and is also connected to image processing device 20 via robot controller 50. Teaching device 40 is used as an operation terminal for performing teaching (program creation) of a motion program of robot 10, teaching (program creation) of a program (hereinafter also referred to as a vision program) related to image-capturing by visual sensor 70 and image processing, display of an image captured by visual sensor 70, and the other various settings. Teaching device 40 may be a teach pendant, or may be formed of a tablet computer and the like. Teaching device 40 may have a hardware configuration as a general computer including a processor, a memory (such as a ROM, a RAM, and a non-volatile memory), a storage device, an operation unit, display unit 41, an input/output interface, a network interface, and the like (see FIG. 2). Display unit 41 is formed of, for example, a liquid crystal display.

FIG. 2 illustrates a functional block diagram related to image processing device 20 and robot controller 50. As illustrated in FIG. 2, the robot controller 50 includes motion control unit 151. Motion control unit 151 controls the motion of robot 10 according to a motion program or an instruction from teaching device 40. The motion program may include the vision program. Robot controller 50 includes a servo control unit (not illustrated) that performs servo control on a servo motor of each axis according to a command for each axis being generated by motion control unit 151.

As illustrated in FIG. 2, image processing device 20 includes visual sensor control unit 121, image acquisition unit 122, camera position acquisition unit 123, robot position acquisition unit 124, feature position registration unit 125, feature position specification unit 126, detection unit 127, learning unit 128, learning image acquisition unit 129, and setting unit 130. As illustrated in FIG. 2, the functional blocks may be achieved by processor 21 executing software.

Visual sensor control unit 121 controls the operation of visual sensor 70. For example, visual sensor control unit 121 may receive an operation command of visual sensor 70 from robot controller 50 (motion control unit 151), and control visual sensor 70. Image acquisition unit 122 acquires an image captured by visual sensor 70.

Camera position acquisition unit 123 provides a function of acquiring a position of visual sensor 70. In the present embodiment, visual sensor 70 is fixedly arranged in the workspace, and camera position acquisition unit 123 provides a position and a posture of visual sensor 70 in the workspace that have been stored in advance in, for example, storage device 22.

Robot position acquisition unit 124 provides a function of acquiring a position of robot 10. Robot position acquisition unit 124 may acquire a position and a posture of robot 10 from motion control unit 151.

Feature position registration unit 125 accepts an input for registering a position of a feature portion of box 90 on an image (hereinafter also referred to as a reference image) in which box 90 placed in a reference position is captured in a preparation stage for collecting learning images. In the present embodiment, the feature portion of box 90 is assumed to be an outer shape of box 90. Feature position registration unit 125 may have a function of providing a user interface that displays a reference image on display unit 41 of teaching device 40, and accepts an operation for designating a position of a feature portion on the reference image via the operation unit of teaching device 40.

Feature position specification unit 126 provides a function of specifying a position of a feature portion of a target object on an image (second image) in which a target object is captured by visual sensor 70 in a state where robot 10 arranges the target object in a new position (second position), based on the registered position of the feature portion with respect to the reference image and a position of robot 10 when robot 10 arranges the target object in the second position. Details of the function of feature position specification unit 126 will be described below.

Learning image acquisition unit 129 has a function of acquiring a great number of learning images while changing various conditions related to image-capturing. Each of the learning images is stored as an annotated image to which a feature position calculated by feature position specification unit 126 is added.

Learning unit 128 performs learning by using the great number of learning images collected as described above to construct a learning model which estimates a position of a feature portion on any image in which a target object is captured.

Detection unit 127 has a function of detecting a target object from an image captured by visual sensor 70. Detection unit 127 has a function of specifying a position of a target object from any image in which the target object is captured by the visual sensor, by using, for example, the learning model constructed by learning unit 128.

Setting unit 130 has a function of accepting various settings related to image processing. Setting unit 130 may be configured to be able to accept a user input for setting a condition related to image-capturing for acquiring a learning image. The condition related to image-capturing may include one or more of an arrangement pattern and an exposure condition of target objects (box 90).

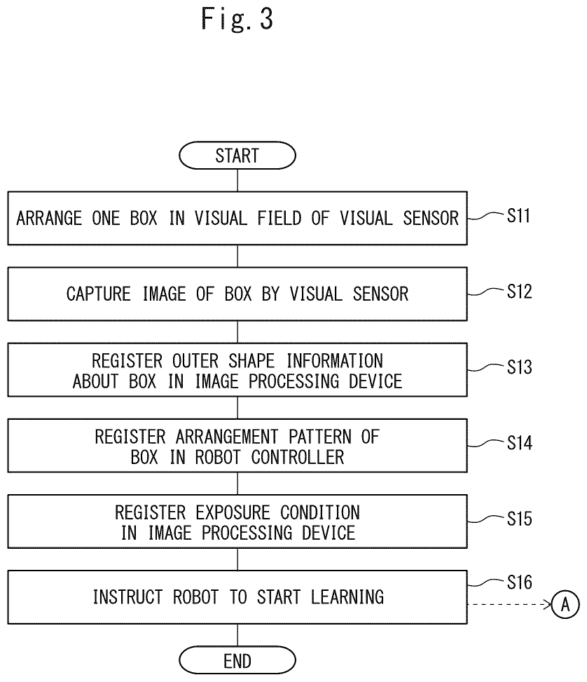

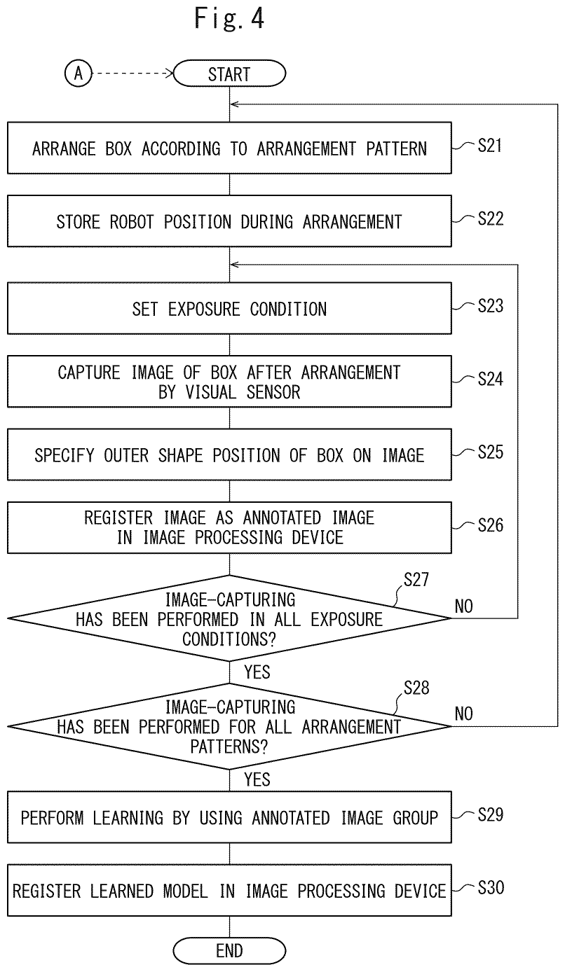

With reference to FIGS. 3 and 4, processing for collecting learning images will be described. The processing for collecting learning images includes processing in a preparation stage (FIG. 3) for registering a feature position of a target object on a reference image in which the target object arranged in a reference position is captured, and learning image acquisition processing (FIG. 4) for storing a great number of learning images as annotated images while changing various conditions related to image-capturing.

FIG. 3 is a flowchart illustrating the processing in the preparation stage. The processing in the preparation stage is processing for setting information being a reference for specifying a feature position in the subsequent learning image acquisition processing (FIG. 4). Thus, in the present specification, a position in which box 90 is arranged in the processing of the preparation stage is also referred to as a reference position, and an image in which box 90 arranged in the reference position is captured is also referred to as a reference image.

First, robot 10 arranges one box 90 in a visual field of visual sensor 70 according to a user operation via teaching device 40 or according to a command being taught to the robot in advance (step S11). A position (reference position) of box 90 arranged herein can be acquired as a position and a posture of robot 10. Robot position acquisition unit 124 acquires a position (reference position) of box 90 as a position and a posture of robot 10.

Next, image processing device 20 controls the visual sensor 70 to capture an image (reference image) of box 90 (step S12). Herein, image-capturing may be performed when a worker inputs a command for image-capturing to visual sensor 70 by operating teaching device 40.

Next, feature position registration unit 125 accepts a user operation for designating a feature position (outer shape position) of box 90 on the reference image (step S13). Herein, a feature on the image is an outer shape of the box as a target object. For example, feature position registration unit 125 may provide a graphical user interface that displays the reference image on display unit 41 of teaching device 40 and accepts an operation for designating the outer shape position of box 90 on the reference image. In this case, for example, the worker designates the outer shape position of the box by performing an operation for drawing a line along an outline of box 90 captured in the image by using a pointing device. Feature position registration unit 125 stores the reference image in association with the feature position designated on the reference image in, for example, storage device 22.

Next, the worker registers, in robot controller 50, an arrangement pattern of the box as an arrangement condition under which robot 10 arranges boxes 90 in an execution stage for acquiring a learning image (step S14). The arrangement pattern of the box corresponds to a condition under which learning images are captured. Setting unit 130 of image processing device 20 may take charge of registration of the arrangement pattern in robot controller 50. In this case, setting unit 130 of image processing device 20 may display a user interface for setting the arrangement pattern on display unit 41 of teaching device 40, and accept setting of the arrangement pattern via the operation unit of teaching device 40. Alternatively, robot controller 50 may take charge of registration of the arrangement pattern.

The arrangement pattern may be various types of information for changing an arrangement state of one or a plurality of boxes 90. For example, the arrangement pattern may be information indicating one or a plurality of positions for arranging box 90. Alternatively, the arrangement pattern may be information designating a height or the number of layers in which boxes are piled up. In this case, robot controller 50 may calculate positions and postures of robot 10 for piling up boxes 90 to the designated height or in the designated number of layers, based on, for example, model data representing a size and a shape of the box. The arrangement pattern may be stored in, for example, a storage unit of robot controller 50.

Next, the worker registers, in image processing device 20, an exposure condition used when a plurality of images are captured in the execution stage for acquiring a learning image (step S15). The exposure condition may include exposure time and a plurality of set values related to intensity of illumination. The exposure condition is stored in, for example, storage device 22 of image processing device 20. Setting unit 130 of image processing device 20 may take charge of registration of the exposure condition. In this case, setting unit 130 of image processing device 20 may display a user interface for setting the exposure condition on display unit 41 of teaching device 40, and accept setting of the exposure condition via the operation unit of teaching device 40. Alternatively, robot controller 50 may take charge of registration of the exposure condition.

Next, the worker instructs robot 10 to start learning (step S16). In response to the instruction, the processing of acquiring a learning image illustrated in FIG. 4 starts. The processing in the preparation stage ends here.

Next, with reference to FIG. 4, the processing (learning image acquisition processing) for acquiring a learning image and performing learning will be described. Learning image acquisition unit 129 (processor 21) takes charge of the learning image acquisition processing in cooperation with robot controller 50 and teaching device 40.

First, robot 10 arranges box 90 in a position designated in the arrangement pattern (step S21). It should be noted that the number of boxes 90 arranged herein (i.e., the number of the boxes captured at once) may be one or may be plural. A position and a posture of robot 10 when the box is arranged according to the arrangement pattern are stored in, for example, storage device 22 by robot position acquisition unit 124 (step S22). The robot position and posture stored herein are used as information indicating a position of box 90 when a learning image is acquired.

Next, image processing device 20 (visual sensor control unit 121) sets an exposure condition according to the set exposure condition (step S23). Then, image processing device 20 (visual sensor control unit 121) controls visual sensor 70 to capture an image of the arranged box 90 (step S24). Image acquisition unit 122 acquires a captured image.

Next, feature position specification unit 126 specifies a position of a feature portion (an outer shape position of the box) on the image (hereinafter also referred to as a second image) acquired in step S24, based on the feature position of box 90 being registered in step S13 in the preparation stage and the position and the posture of robot 10 being recorded in step S22 (step S25). Specifically, feature position specification unit 126 specifies a feature position of box 90 on the second image, based on a position and a posture of robot 10 when robot 10 arranges box 90 in the reference position, a position and a posture of robot 10 when robot 10 arranges box 90 according to the arrangement pattern, a position and a posture of visual sensor 70 when each of the reference image and the second image is captured, and the registered feature position on the reference image. It should be noted that, in the present embodiment, visual sensor 70 is fixedly arranged, and thus a position and a posture of visual sensor 70 when each of the reference image and the second image is captured are the same.

Image processing device 20 (learning image acquisition unit 129) registers, as an annotated learning image, the learning image acquired in step S24 by adding the feature position information acquired in step S25 to the learning image (step S26). The annotated learning image is stored in, for example, storage device 22.

Next, image processing device 20 (learning image acquisition unit 129) determines whether image-capturing has performed in all the designated exposure conditions (step S27). When image-capturing in all the exposure conditions has not ended (S27: NO), image processing device 20 (learning image acquisition unit 129) executes the processing from step S23 again for a next exposure condition.

When image-capturing in all the exposure conditions has been performed (S27: YES), the processing proceeds to step S28. In step S28, image processing device 20 (learning image acquisition unit 129) determines whether the operation of arranging box 90 according to all the designated arrangement patterns and performing image-capturing has been performed. When image-capturing in all the arrangement patterns has not been completed (S28: NO), the processing from the operation (step S21) for arranging box 90 in a next arrangement position by robot 10 according to the arrangement pattern is executed again.

When image-capturing in all the arrangement patterns has been completed (S28: YES), collection of the learning images has been completed, and the processing proceeds to step S29. As described above, a great number of the learning images according to all the arrangement patterns and the exposure conditions are acquired. Specifically, learning images the number of which is determined by multiplying the number of arrangement positions included in the arrangement pattern by the number of exposure conditions are acquired.

In step S29, image processing device 20 (learning unit 128) performs learning by using the annotated learning images collected as described above. As one example, learning unit 128 performs learning by supervised learning as one of the pieces of machine learning. A technique of deep learning may be incorporated into learning. Learning unit 128 causes a neural network (NN) or a convolutional neural network (CNN) as an estimator to learn supervised data in which the learning image is used as an input and a feature position specified for the image is a correct answer. In this way, a learning model for estimating the feature position on any image in which box 90 as a target object is captured can be constructed.

Next, image processing device 20 (learning unit 128) registers the learning model constructed by learning (step S30). The learning model is stored in, for example, storage device 22. The learning image acquisition processing ends through the processing described above.

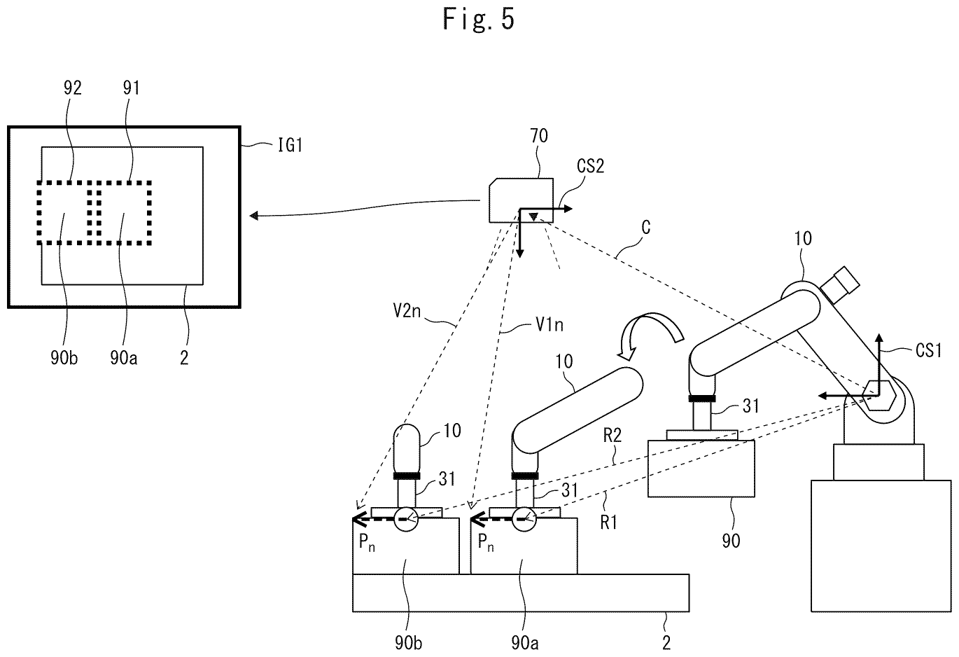

Herein, calculation of a feature position on an image (i.e., specification of an outer shape position in step S25) by feature position specification unit 126 will be described with reference to FIG. 5. FIG. 5 illustrates a situation where robot 10 arranges box 90 in a reference position by hand 31 and a situation where robot 10 arranges box 90 by hand 31 in one position in the designated arrangement pattern. It should be noted that an adsorption hand is used as hand 31 herein. For the convenience of description, a box placed in the reference position is indicated by a reference sign 90a, and a box arranged in the position according to the arrangement pattern is indicated by a reference sign 90b.

Image IG1 illustrates an example of an image captured by visual sensor 70 in the arrangement situation of box 90 as in FIG. 5. It should be noted that box 90a and box 90b are actually captured as separate images, but are illustrated in one image IG1 herein for convenience of explanation. In image IG1, a broken line indicated by a reference sign 91 indicates an outer shape position registered by the worker for box 90a. In image IG1, a broken line indicated by a reference sign 92 indicates a feature position of box 90b specified by feature position specification unit 126.

In FIG. 5,
C represents a position of a camera coordinate system CS2 viewed from a reference coordinate system (robot coordinate system) CS1 of robot 10,
R1 represents a reference position of robot 10 viewed from the reference coordinate system CS1 when robot 10 places box 90 in the reference position,
V1ₙ represents an outer shape position of a reference target object (box 90a arranged in the reference position) viewed from the camera coordinate system CS2, and
Pₙ represents an outer shape position of box 90 (90a) viewed from the reference position (reference coordinate system CS1) of robot 10.
   When a line length (pixel number) of an outer shape (outline) is 100, n is 1 to 100.

A feature position of box 90 on an image, i.e., the outer shape position V1ₙ on the camera coordinate system CS1 is registered by registration of a feature position by feature position registration unit 125 (registration of an outer shape position in step S13). Therefore, the outer shape position V1ₙ is already known. Further, the position C in the camera coordinate system CS2 viewed from the reference coordinate system (robot coordinate system) CS1 of robot 10 is already known from calibration data. Further, the reference position R1 of robot 10 can be acquired from robot 10 (robot controller 50).

Feature position specification unit 126 can obtain the outer shape position Pₙ on the reference coordinate system CS1 from C, R1, and V1ₙ by the following numerical expression (1). It should be noted that C, R1, V1ₙ, and Pₙ are expressed by a homogeneous transformation matrix.

$$R {1}^{- 1} * C * V {1}_{n} = {p}_{n} \qquad ( 1 )$$

Further, in FIG. 5,
R2 represents a position of robot 10 viewed from the reference coordinate system CS1 when robot 10 arranges box 90 (90b) in the execution stage for acquiring a learning image, and
V2ₙ represents an outer shape position of box 90 (90b) viewed from the camera coordinate system CS2 on the learning image.
   V2ₙ is an outer shape position of box 90 (90b) on the learning image that is desired to be obtained in the end.

Feature position specification unit 126 can obtain V2ₙ from R2 and Pₙ by the following numerical expression (2). It should be noted that R2 and V2ₙ are expressed by a homogeneous transformation matrix.

$${C}^{- 1} * R 2 * {p}_{n} = V {2}_{n} \qquad ( 2 )$$

It should be noted that, when each of box 90a and box 90b is grasped by hand 31, the same position on the box (for example, a center position of an upper surface of box 90a and box 90b) is grasped.

The learning image is stored as an annotated image by adding the outer shape position V2ₙ specified in such a manner to the learning image.

Image processing device 20 acquires a position of box 90 as a position of robot 10, and can thus automatically acquire information needed for calculating the outer shape position V2ₙ in the learning image. When the worker performs, in advance, registration of a feature position (outer shape information) and registration of a condition related to image-capturing on robot controller 50 or image processing device 20, acquisition of a great number of learning images and specification of a feature position on the learning images are automatically performed. Therefore, according to the present embodiment, a load on the worker in acquisition of the learning images is greatly reduced.

Thus, a learning model for improving the recognition rate of a target object can be constructed by using the great number of learning images.

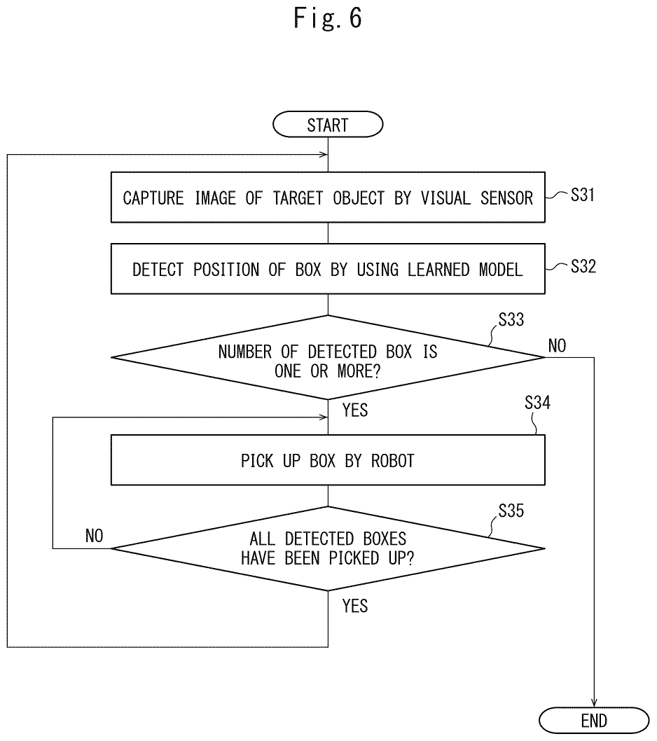

FIG. 6 is a flowchart illustrating box picking-up processing during the actual operation of robot system 100. The box picking-up processing is executed under control mainly by the processor of robot controller 50. First, robot controller 50 controls, via image processing device 20, visual sensor 70 to capture an image of box 90 (step S31). Image processing device 20 detects positions (outer shape positions) and the number of boxes 90 from the captured image by using a learning model (step S32). Image processing device 20 provides the detected position and the detected number of boxes 90 to robot controller 50.

Robot controller 50 determines whether the box that has been detected is one or more (step S33). When the number of detected boxes is one or more (S33: YES), robot controller 50 executes a motion of picking up the detected box 90 by robot 10 (step S34). Picking up of box 90 by robot 10 is performed on all the detected boxes (S35: NO). When all the detected boxes have been picked up (S35: YES), box 90 mounted on pallet 2 is newly supplied, and the processing from step S31 continues for the newly supplied box 90. When no box is detected in step S33 (S33: NO), the present box picking up processing ends.

### Second Embodiment

Hereinafter, a robot system including an image processing device according to a second embodiment will be described. A configuration of the robot system according to the second embodiment is common to robot system 100 according to the first embodiment, except that visual sensor 70 is arranged in a movable portion (such as an arm tip portion) of robot 10. Further, a configuration of a functional block of each device according to the second embodiment is common to the functional block diagram illustrated in FIG. 2. Therefore, the function of each device according to the second embodiment is described with reference to the functional block diagram in FIG. 2 by using the same reference signs as those of the first embodiment.

Also in the second embodiment, visual sensor 70 has already been subjected to calibration, and thus a position and a posture of visual sensor 70 with respect to a coordinate system (for example, a flange coordinate system) set on robot 10 are already known. Further, a position and a posture of the flange coordinate system with respect to the reference coordinate system (robot coordinate system) set on robot 10 are already known. Therefore, by acquiring a position and a posture of robot 10, a position and a posture of visual sensor 70 with respect to the reference coordinate system (robot coordinate system) set on robot 10 can be decided. In the present embodiment, camera position acquisition unit 123 acquires a position and a posture of visual sensor 70 from a position and a posture of robot 10.

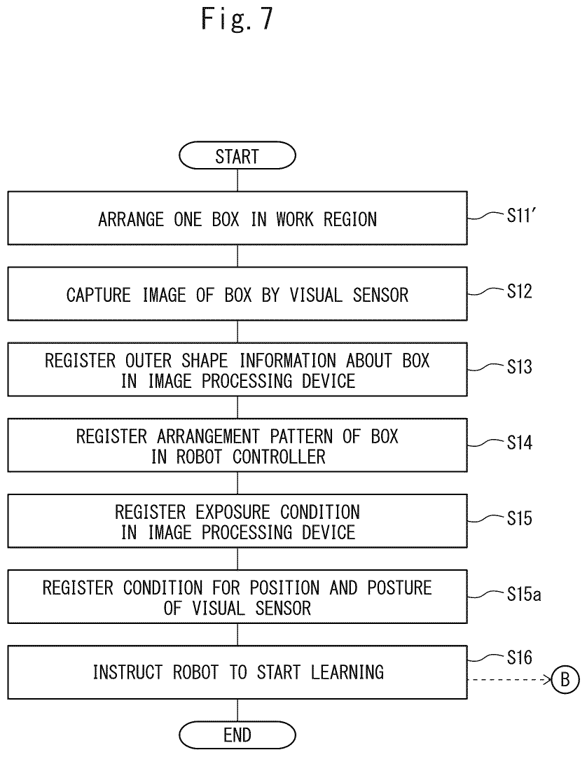

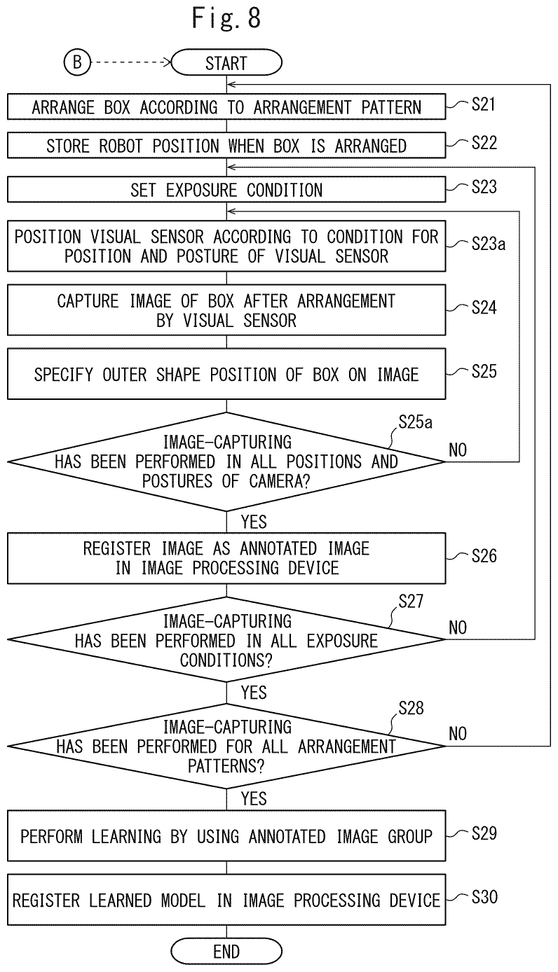

With reference to FIGS. 7 and 8, processing for collecting learning images in the second embodiment will be described. FIG. 7 corresponds to the processing in FIG. 3 in the first embodiment and illustrates processing in a preparation stage for registering a feature position of a target object on a reference image in which the target object arranged in a reference position is captured. FIG. 8 corresponds to the processing in FIG. 4 in the first embodiment and illustrates learning image acquisition processing for storing a great number of learning images as annotated images while changing various conditions related to image-capturing. In FIGS. 7 and 8, to the steps which are the same as those of the first embodiment, the same reference numbers are assigned, and description thereof will be omitted or simplified.

As illustrated in FIG. 7, in the processing in the preparation stage, first, robot 10 arranges one box 90 in a work region according to a user operation via teaching device 40 or according to a command being taught to robot 10 in advance (step S11′). Since visual sensor 70 is mounted on robot 10 and an image-capturing range of visual sensor 70 is not fixed, robot 10 may arrange box 90 in any position in the work region. Then, image-capturing of box 90 is performed by visual sensor 70 mounted on robot 10 (step S12). Herein, image-capturing may be performed by a worker operating teaching device 40, positioning robot 10 in a position and a posture in which an image of box 90 can be captured, and also inputting a command for image-capturing to visual sensor 70. The processing in steps S13 to S15 is the same as the processing in the case of the first embodiment illustrated in FIG. 3, and thus description thereof will be omitted.

In the present embodiment, visual sensor 70 is arranged on the arm tip portion (for example, a hand device) of robot 10, and visual sensor 70 can be positioned in any position and posture by controlling robot 10. Thus, in the present embodiment, a condition for a position and a posture of visual sensor 70 can be set as a condition related to capturing of a learning image. In this way, a greater number of learning images can be acquired by changing the position and the posture of visual sensor 70. In step S15a, the worker registers a condition for a position and a posture of visual sensor 70 in image processing device 20. In this case, setting unit 130 of image processing device 20 may display a user interface for setting the condition for the position and the posture of visual sensor 70 on display unit 41 of teaching device 40, and accept setting of the condition for the position and the posture of visual sensor 70 via the operation unit of teaching device 40. Alternatively, robot controller 50 may take charge of registration of the condition for the position and the posture of visual sensor 70.

Then, the worker instructs robot 10 to start learning (step S16). In response to the instruction, the processing of acquiring a learning image illustrated in FIG. 8 starts. The processing in the preparation stage ends here.

The learning image acquisition processing according to the second embodiment illustrated in FIG. 8 has a configuration in which loop processing of repeating image-capturing according to a condition related to a position and a posture of visual sensor 70 is added to the learning image acquisition processing according to the first embodiment illustrated in FIG. 4. Therefore, the loop processing of repeating image-capturing according to a condition related to a position and a posture of visual sensor 70 will be described herein. After setting an exposure condition in step S23, learning image acquisition unit 129 instructs robot controller 50 to position visual sensor 70 according to the condition related to the position and the posture of visual sensor 70 being set in step S15a (step S23a).

Then, after image-capturing of a box is performed and specification of an outer shape position of the box is performed (steps S24 to S25), learning image acquisition unit 129 determines whether image-capturing has been performed in all the positions and the postures of visual sensor 70 being registered in step S15a (step S25a). When image-capturing has not been performed in all the registered positions and the registered postures of visual sensor 70 (step S25a: NO), the processing returns to step S23a, and visual sensor 70 is positioned in the next registered position and registered posture. When image-capturing has been performed in all the registered positions and the postures of visual sensor 70 (S25a: YES), the processing proceeds to step S26. In step S26, images acquired in all the camera positions and postures and outer shape positions specified for the camera positions and postures are stored as annotated images. The processing in and after step S26 is the same as that in the case of the first embodiment (FIG. 4), and thus description thereof will be omitted.

It should be noted that the example of repeatedly acquiring an image while changing a position and a posture of visual sensor 70 according to a condition for a position and a posture of visual sensor 70 being preregistered by the worker in step S15a is described herein, but learning image acquisition unit 129 may be configured to automatically set a condition related to a position and a posture of visual sensor 70. For example, learning image acquisition unit 129 may set a plurality of image-capturing positions in a workspace, and decide a posture of visual sensor 70 in such a way that box 90 enters a visual field of visual sensor 70 in each of the image-capturing positions, based on a position and a posture of robot 10 when robot 10 arranges box 90 (i.e., arrangement information about box 90). In this case, the worker does not need to perform registration of a condition related to a position and a posture of visual sensor 70 (step S15a).

By the processing described above, a great number of learning images can be collected based on all of a condition related to an arrangement pattern, an exposure condition, and a condition related to a position and a posture of the visual sensor. Specifically, when the number of arrangement positions included in an arrangement pattern is set as K₁, the number of exposure conditions is set as K₂, and the number of conditions related to a position and a posture of the visual sensor is set as K₃, the number of learning images represented by K₁×K₂×K₃ is acquired.

It should be noted that, in the case of the present embodiment, the position of visual sensor 70 when a reference image is acquired in the preparation stage (FIG. 7) and the position of visual sensor 70 in the execution stage for acquiring a learning image (FIG. 8) are different. In this case, feature position specification unit 126 can obtain the outer shape position Pₙ on the reference coordinate system CS1 by the following numerical expression (3). The position of the camera coordinate system CS2 viewed from the reference coordinate system (robot coordinate system) CS1 of robot 10 when a reference image is captured is set as C₁, and the other symbols R1 and V1ₙ are assumed to be the same as those described above. The position C₁ can be acquired from a position and a posture of robot 10 that arranges box 90 in a reference position. Camera position acquisition unit 123 can calculate and provide the position C₁.

$$R {1}^{- 1} * {C}_{1} * V {1}_{n} = {p}_{n} \qquad ( 3 )$$

Furthermore, feature position specification unit 126 can obtain the outer shape position V2ₙ of box 90 in a learning image by the following numerical expression (4). The position of the camera coordinate system CS2 viewed from the reference coordinate system (robot coordinate system) CS1 of robot 10 when a learning image is captured is set as C₂, and the other symbols R2, Pₙ, and V2ₙ are assumed to be the same as those described above. The position C₂ can be acquired from a position and a posture of robot 10 that arranges the box according to an arrangement pattern. Camera position acquisition unit 123 can calculate and provide the position C₂.

$${C}_{2}^{- 1} * R 2 * {P}_{n} = V {2}_{n} \qquad ( 4 )$$

Therefore, also in the case of the present embodiment, similarly to the case of the first embodiment, acquisition of a great number of learning images and specification of a feature position on the learning images are automatically performed. Therefore, according to the present embodiment, the load on the worker in acquisition of the learning images is greatly reduced. Particularly, in the second embodiment, a condition related to a position and a posture of the visual sensor is used as a condition related to image-capturing, in addition to a condition related to an arrangement pattern and an exposure condition. Thus, a greater number of learning images can be acquired.

Then, a learning model for improving the recognition rate of a target object can be constructed by using the great number of learning images.

In each of the embodiments described above, the example in which robot 10 arranges a box according to an arrangement pattern designated by the worker as a condition related to an arrangement of the box in the learning image acquisition processing is described, but various examples of a condition related to an arrangement of a box are possible. For example, an example in which robot 10 arranges a box in a position randomly selected in a work region is also possible. In this case, learning image acquisition unit 129 of robot controller 50 or image processing device 20 executes processing of randomly selecting a position of the box in the work region. A great number of learning images can be acquired by applying the above-described learning image acquisition processing while changing the arrangement of the box in such a manner.

Alternatively, a configuration in which the worker arranges a plurality of boxes in advance and acquisition of positions of robot 10 and image-capturing are performed while robot 10 picks up a part of the boxes is also possible. Robot 10 picks up the plurality of arranged boxes in order, and thus a great number of learning images in which an arrangement state of the boxes changes can be acquired. In this case, position information about a first arrangement state of the boxes is registered in advance in robot controller 50 or image processing device 20. Robot controller 50 or image processing device 20 can always recognize an arrangement state of the boxes by recognizing a position of the box to be picked up by information regarding the position and the posture of robot 10 when robot 10 picks up the box. A great number of learning images can be acquired by applying the above-described learning image acquisition processing while changing the arrangement state of the boxes in such a manner.

The above-described embodiments are the configuration example in a case of collecting a learning image in which an outer shape position as a feature position of a box as a target object is associated with an image of the box, but the configuration of each of the above-described embodiments can be applied to automatic collection of learning images of various types in which learning data is generated by associating information about a feature portion of a target object with an image of the target object.

A function arrangement in the functional block diagram illustrated in FIG. 2 is an example, and various modification examples of the function arrangement are possible. For example, a configuration example in which the function as image processing device 20 is integrally incorporated into robot controller 50 is also possible. In this case, the processor of robot controller 50 has functions as visual sensor control unit 121, image acquisition unit 122, camera position acquisition unit 123, robot position acquisition unit 124, feature position registration unit 125, feature position specification unit 126, detection unit 127, learning unit 128, learning image acquisition unit 129, and setting unit 130. Alternatively, a configuration in which the function as image processing device 20 is arranged in teaching device 40 is also possible. Alternatively, a configuration in which the function as image processing device 20 is distributed and arranged in robot controller 50 and teaching device 40 is also possible.

A system configuration in which a part of the functions arranged in image processing device 20 in FIG. 2 is arranged in the other device (robot controller 50 or teaching device 40) is also possible. For example, the function as setting unit 130 may be arranged in robot controller 50 or teaching device 40.

In each of the above-described embodiments, the example in which the visual sensor is a three-dimensional camera is described. In a case of an application example in which detection and handling of a target object can be achieved by recognizing a feature position of the target object as two-dimensional position information, the visual sensor may be a two-dimensional camera.

The functional block of the image processing device illustrated in FIG. 2 may be achieved by executing various types of software stored in a storage device by one or the plurality of processors of the image processing device, or may be achieved by a configuration in which hardware such as an application specific integrated circuit (ASIC) is a main body.

The program for executing various types of processing such as the learning image acquisition processing in the embodiments described above can be recorded in various computer-readable recording media (for example, a ROM, an EEPROM, a semiconductor memory such as a flash memory, a magnetic recording medium, and an optical disk such as a CD-ROM and a DVD-ROM).

As described above, according to each of the embodiments, a great number of learning images can be automatically acquired.

Although the present disclosure has been described above in detail, the present disclosure is not limited to the individual embodiments described above. Various types of addition, replacement, modification, partial deletion, and the like may be made to the embodiments without departing from the purpose of the present disclosure or without departing from the contents described in the claims and the scope of the present disclosure derived from equivalents thereof. Further, the embodiments can also be executed in combination. For example, in the embodiments described above, an order of operations and an order of pieces of processing are indicated as one example, which is not limited thereto. Further, the same also applies to a case where a numerical value or a numerical expression is used in the description of the embodiments described above.

With regard to the embodiments and the modification examples described above, supplementary notes below are further described.

### Supplementary Note 1

An image processing device (20) including:
an image acquisition unit (122) configured to acquire an image of a target object by a visual sensor (70);
a robot position acquisition unit (124) configured to acquire a position of a robot (10) configured to be movable while grasping the target object;
a storage unit (22) configured to store a position of a feature portion of the target object on a first image of the target object captured by the visual sensor (70) in a state where the robot (10) arranges the target object in a first position; and
a feature position specification unit (126) configured to specify a position of the feature portion of the target object on a second image of the target object captured by the visual sensor (70) in a state where the robot (10) arranges the target object in a second position, based on a position of the robot (10) when the robot (10) arranges the target object in each of the first position and the second position, a position of the visual sensor (70) when each of the first image and the second image is captured, and a position of the feature portion on the first image.

### Supplementary Note 2

The image processing device (20) according to supplementary note 1, wherein
the visual sensor (70) is fixedly arranged in a workspace, and has already been subjected to calibration, and
the feature position specification unit (126) is configured to acquire, as the position of the visual sensor when each of the first image and the second image is captured, a position of the visual sensor fixedly arranged in the workspace.

### Supplementary Note 3

The image processing device (20) according to supplementary note 1, wherein
the visual sensor (70) is mounted on a movable portion of the robot, and has already been subjected to calibration, and
the feature position specification unit (126) is configured to acquire a position of the visual sensor (70) when each of the first image and the second image is captured, based on a position of the robot (10) when each of the first image and the second image is captured.

### Supplementary Note 4

The image processing device (20) according to supplementary note 1, further including
a learning image acquisition unit (129) configured to control the visual sensor (70) to capture a plurality of the second images, based on a condition related to image-capturing, and store, as a plurality of learning images, the plurality of second images in association with a position of the feature portion specified for each of the plurality of second images.

### Supplementary Note 5

The image processing device (20) according to supplementary note 4, wherein
the condition related to the image-capturing includes an arrangement condition related to an arrangement of the target object, and
the learning image acquisition unit (129) is configured to acquire the plurality of second images by controlling the visual sensor (70) to perform image-capturing in each state where the robot (10) changes an arrangement position of the target object according to the arrangement condition.

### Supplementary Note 6

The image processing device (20) according to supplementary note 4 or 5, wherein
the condition related to the image-capturing includes an exposure condition, and
the learning image acquisition unit (129) is configured to acquire the plurality of second images by controlling the visual sensor (70) to repeatedly perform image-capturing while changing an exposure condition for the target object arranged in the second position.

### Supplementary Note 7

The image processing device (20) according to any one of supplementary notes 4 to 6, wherein
the condition related to the image-capturing includes a condition for a position or a posture of the visual sensor (70), and
the learning image acquisition unit (129) is configured to acquire the plurality of second images by controlling the visual sensor (70) to repeatedly perform image-capturing while changing a position or a posture of the visual sensor (70) with respect to the target object arranged in the second position.

### Supplementary Note 8

The image processing device (20) according to any one of supplementary notes 4 to 7, further including
a setting unit (130) configured to accept an input for setting the condition related to the image-capturing.

### Supplementary Note 9

The image processing device (20) according to any one of supplementary notes 4 to 8, further including
a learning unit (128) configured to construct a learning model for estimating a position of the feature portion on any image in which the target object is captured by performing learning, based on the plurality of learning images.

### Supplementary Note 10

The image processing device (20) according to any one of supplementary notes 1 to 9, further including
a feature position registration unit (125) configured to accept a user operation for designating a position of the feature portion of the target object on the first image.

### REFERENCE SIGNS LIST

10 Robot
20 Image processing device
21 Processor
22 Storage device
31 Hand
40 Teaching device
41 Display unit
50 Robot controller
70 Visual sensor
100 Robot system
121 Visual sensor control unit
122 Image acquisition unit
123 Camera position acquisition unit
124 Robot position acquisition unit
125 Feature position registration unit
126 Feature position specification unit
127 Detection unit
128 Learning unit
129 Learning image acquisition unit
130 Setting unit

1. An image processing device comprising:
an image acquisition unit configured to acquire an image of a target object captured by a visual sensor;
a robot position acquisition unit configured to acquire a position of a robot configured to be movable while grasping the target object;
a storage unit configured to store a position of a feature portion of the target object on a first image of the target object captured by the visual sensor in a state where the robot arranges the target object in a first position; and
a feature position specification unit configured to specify a position of the feature portion of the target object on a second image of the target object captured by the visual sensor in a state where the robot arranges the target object in a second position, based on a position of the robot when the robot arranges the target object in each of the first position and the second position, a position of the visual sensor when each of the first image and the second image is captured, and a position of the feature portion on the first image.

2. The image processing device according to claim 1, wherein
the visual sensor is fixedly arranged in a workspace, and has already been subjected to calibration, and
the feature position specification unit is configured to acquire, as the position of the visual sensor when each of the first image and the second image is captured, a position of the visual sensor fixedly arranged in the workspace.

3. The image processing device according to claim 1, wherein
the visual sensor is mounted on a movable portion of the robot, and has already been subjected to calibration, and
the feature position specification unit is configured to acquire the position of the visual sensor when each of the first image and the second image is captured, based on a position of the robot when each of the first image and the second image is captured.

4. The image processing device according to claim 1, further comprising
a learning image acquisition unit configured to control the visual sensor to capture a plurality of the second images, based on a condition related to image-capturing, and store, as a plurality of learning images, the plurality of second images in association with a position of the feature portion specified for each of the plurality of second images.

5. The image processing device according to claim 4, wherein
the condition related to the image-capturing includes an arrangement condition related to an arrangement of the target object, and
the learning image acquisition unit is configured to acquire the plurality of second images by controlling the visual sensor to perform image-capturing in each state where the robot changes an arrangement position of the target object according to the arrangement condition.

6. The image processing device according to claim 4, wherein
the condition related to the image-capturing includes an exposure condition, and
the learning image acquisition unit is configured to acquire the plurality of second images by controlling the visual sensor to repeatedly perform image-capturing while changing an exposure condition for the target object arranged in the second position.

7. The image processing device according to claim 4, wherein
the condition related to the image-capturing includes a condition for a position or a posture of the visual sensor, and
the learning image acquisition unit is configured to acquire the plurality of second images by controlling the visual sensor to repeatedly perform image-capturing while changing a position or a posture of the visual sensor with respect to the target object arranged in the second position.

8. The image processing device according to claim 4, further comprising
a setting unit configured to accept an input for setting the condition related to the image-capturing.

9. The image processing device according to claim 4, further comprising
a learning unit configured to construct a learning model for estimating a position of the feature portion on any image in which the target object is captured by performing learning, based on the plurality of learning images.

10. The image processing device according to claim 1, further comprising
a feature position registration unit configured to accept a user operation for designating a position of the feature portion of the target object on the first image.
